(19) United States
(12) Patent Application Publication
(10) Pub. No.: US 2012/0176341 A1
(43) Pub. Date: Jul. 12, 2012

(54) METHOD AND APPARATUS FOR CAMERA PROJECTOR SYSTEM FOR ENABLING AN INTERACTIVE SURFACE

(75) Inventors: Goksel Dedeoglu, Plano, TX (US); Marshall Charles Capps, Farmers Branch, TX (US)

(73) Assignee: TEXAS INSTRUMENTS INCORPORATED, Dallas, TX (US)

(21) Appl. No.: 13/348,320

(22) Filed: Jan. 11, 2012

Related U.S. Application Data
(60) Provisional application No. 61/431,513, filed on Jan. 11, 2011.

(51) Int. Cl. G06F 3/042

(52) U.S. Cl. 345/175

(57) ABSTRACT

A method and apparatus for enabling an interactive surface. The method includes determining pixels of a depth image relating to an object at least one of touching or in close proximity to a related surface, differentiating between a small and a larger cluster of pixels, determining smaller cluster of pixels to be a level1 blob and the larger cluster of pixels to be a level2 blob and declaring the level1 blob an object touching the surface, and computing the coordinates of the level1 blob and repeating the process to enable the interactive surface.

### CROSS-REFERENCE TO RELATED APPLICATIONS

This application claims benefit of U.S. provisional patent application Ser. No. 61/431,513, filed Jan. 11, 2010, which is herein incorporated by reference.

### BACKGROUND OF THE INVENTION

1. Field of the Invention

Embodiments of the present invention generally relate to a method and apparatus for camera projector system for enabling an interactive surface.

2. Description of the Related Art

Projection surfaces are widely used in classrooms and meeting rooms. For a surface to be interactive, it is typically required to engineer the surface with touch sensors. Interactivity includes, for example, touching virtual buttons on the screen, selecting items, using hands and fingers to paint or to write. Using a touch sensor on a surface has proven to be costly and prone to calibration and accuracy problems.

Therefore, there is a need for a method and/or apparatus for improving the interactive surface.

### SUMMARY OF THE INVENTION

Embodiments of the present invention relate to a method and apparatus for enabling an interactive surface. The method includes determining pixels of a depth image relating to an object at least one of touching or in close proximity to a related surface, differentiating between a small and a larger cluster of pixels, determining smaller cluster of pixels to be a level1 blob and the larger cluster of pixels to be a level2 blob and declaring the level1 blob an object touching the surface, and computing the coordinates of the level1 blob and repeating the process to enable the interactive surface.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of long and short throw geometries;

FIG. 2 is an embodiment of a method for enabling a surface for interaction in a long-throw geometry at a small (1:10) scale.

FIG. 3 is an embodiment of a method for enabling a surface for interaction in a short-thrown geometry in realistic scale (1:1);

FIG. 4 is an embodiment of a pattern utilized to facilitate stereo vision; and

FIG. 5 is an embodiment of sample images of a scene filled with the structured light pattern (left), and the depth images estimated through stereo vision (right);

FIG. 6 is an embodiment of a hand painting demo enabled by the touch detection;

FIG. 7 is an embodiment of a flow diagram depicting a method for displaying or performing a command based on gesture on a projection surface; and

FIG. 8 is an embodiment of a method for enabling an interactive surface.

### DETAILED DESCRIPTION

Herein an interactive surface is any surface being used for presentation, such as, a white board, a projection screen, a black board, etc. In one embodiment, a camera projector system is utilized to enable interactivity on such a surface. The camera projector introduces a depth sensing capability. Thus, the depth data is processed to infer interactivity events, such as, hands/fingers touching the projection surface in order to facilitate interactions between the user and the system.

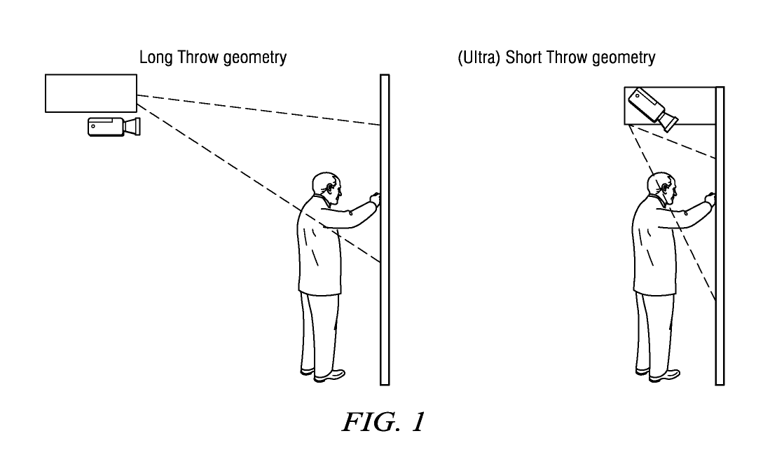

FIG. 1 depicts long and short throw geometries. In FIG. 1, a camera-projector system enables an interactive surface. Thus, a projection surface may become an interactive surface without having to engineer the wall with touch sensors, which allows for, for example, touching virtual buttons on the screen, selecting items, using hands and fingers to paint or to write, etc. In one embodiment, events may be defined through hovering of hands or fingers.

The camera projector system performs depth sensing and performs depth data analysis to determine user actions and support interactivity. To perform the depth sensing, a geometric triangulation approach is used. To perform the depth sensing, the system establishes pixel-wise correspondence between two or more views. In the stereo vision approach, for example, the views are the “left” and “right” images coming from two cameras observing the scene. In the structured light approach, one of the cameras is replaced with an active illumination source, such as, a laser stripe or a projector. In stereo vision, the pixel-wise correspondence needs to be established between two images, which may not be known ahead of time. In structured light, the correspondence of interest is between an a priori known pattern and an image of it captured through a camera.

In one embodiment, a projector may be used, such as, a Digital Light Processing (DLP) projection system, to facilitate both stereo vision and structured light. These systems have high projection frame rate and capability to project arbitrary images.

Utilizing high projector frame rates, a highly textured pattern is intermittently projected onto the surface. The highly textured pattern is then followed by its negative. In one embodiment, the duration of the projections is short enough that the human eye integrates these two images to a “flat field”. It is possible to configure and to synchronize cameras such that the cameras capture one or more of the patterns. Such patterns may be injected into a presentation, movie, or any subject matter being projected.

In stereo vision, one may deploy a highly textured projection pattern, which may be invisible to the human eye, to ensure optimal performance of the depth estimation algorithm. The projected texture provides unique visual signatures for the stereo algorithm to match left and right image pixels.

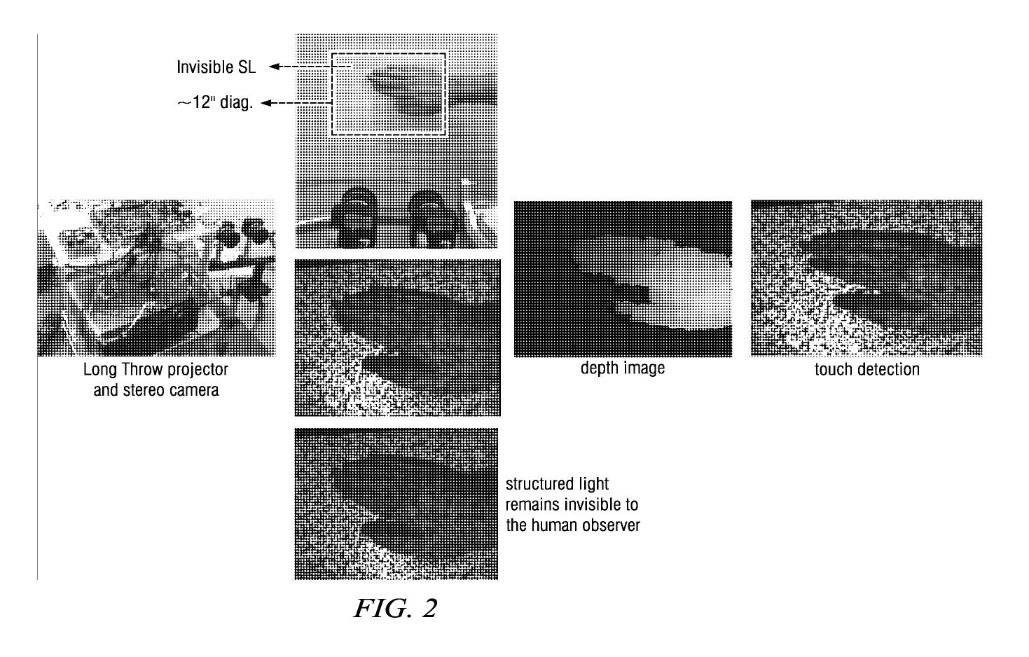

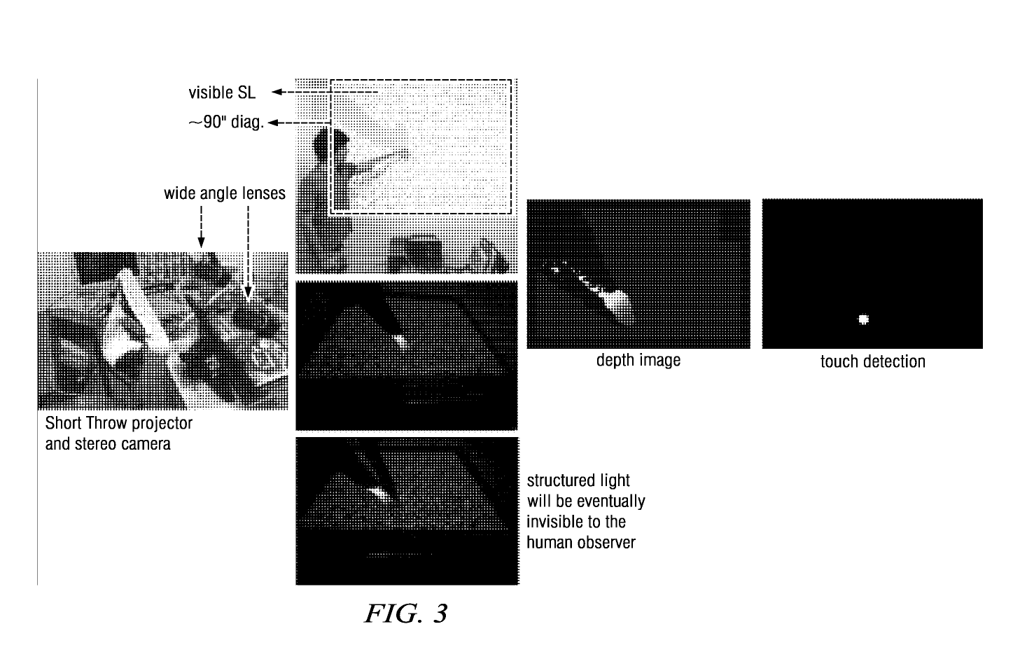

FIG. 2 is an embodiment of patterns for facilitating stereo vision in the long throw projection geometry. FIG. 3 is an embodiment for using invisible patterns to facilitate stereo vision in the ultra short throw projection geometry. As shown in FIG. 2 the structured light remains invisible to the human observer, as shown in FIG. 9. Whereas, in FIG. 3, the structured light eventually become invisible to the human observer. However, in both FIG. 2 and FIG. 3, depth sensing and tough detection are performed.

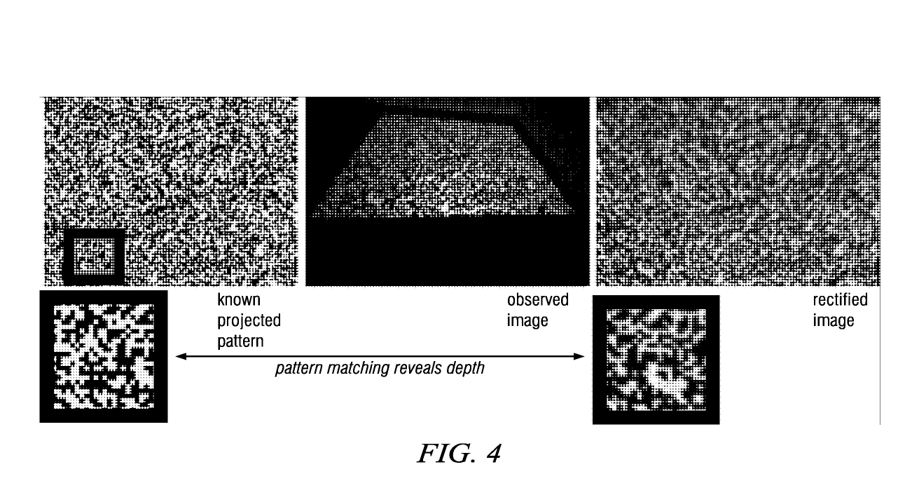

FIG. 4 is an embodiment of an invisible pattern utilized to facilitate depth sensing. In structure light of FIG. 4, the pattern that is projected onto the scene is matched against the observed image. As shown in FIG. 4, the correspondence problem is now between an ideal pattern and its observation through a camera. In one embodiment, flexibility over projected patterns is utilized. When there is control over a hidden pattern to be projected, one may be able to adapt the latter to the scene in the most informative way. For instance, when ambiguous matches are detected between the left and right views, the pattern may be maneuvered so as to remove the ambiguity. Also, the scale of the pattern may be adjusted according to the observations. For example, if the texture is too small or smeared due to low resolution, one may magnify it to make it more visible & easier to match. In other embodiment, the texture may appear too big, thus, one may add finer visual details to it to make a better use of the available resolution. Such comparison may be observed in the top and the bottom images of FIG. 4.

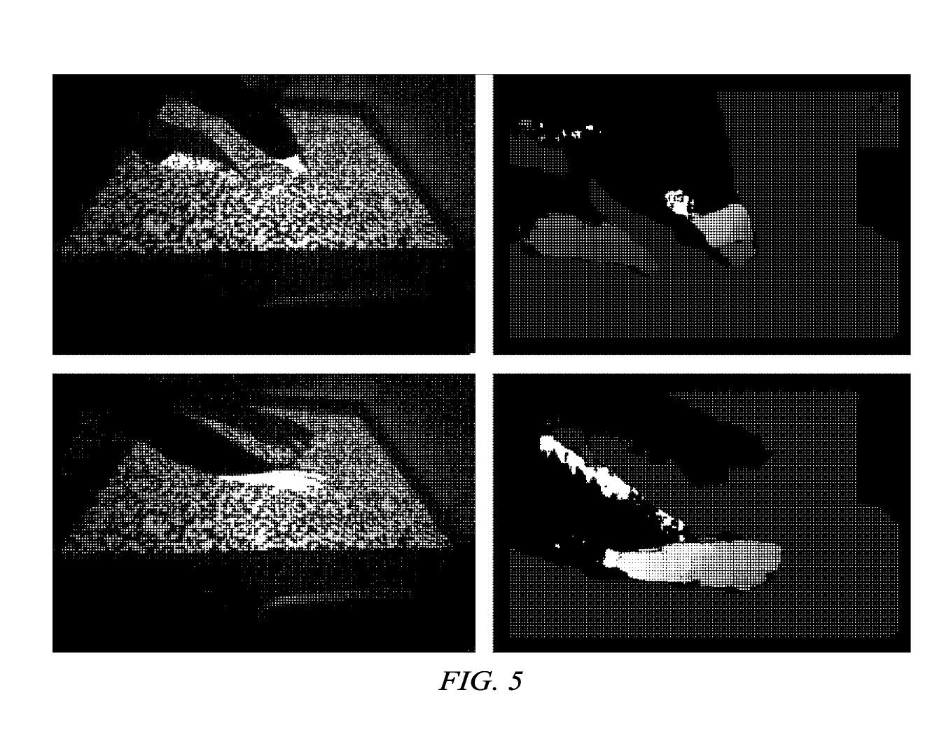

For Depth analysis for gesture analysis, one may analyze the depth images for objects that are around the size of a human hand or fingers, which are touching or closely hovering over the projection surface. FIG. 5 is an embodiment of sample images of a scene filled with the structured light pattern (left), and the depth images estimated through stereo vision (right). Depth is encoding false color in the lower right image. In FIG. 5, a sampling of depth images is shown along with the corresponding “left” image, which was contrast-enhanced to facilitate viewing. It should be noted that the images maybe colored images or black and white images.

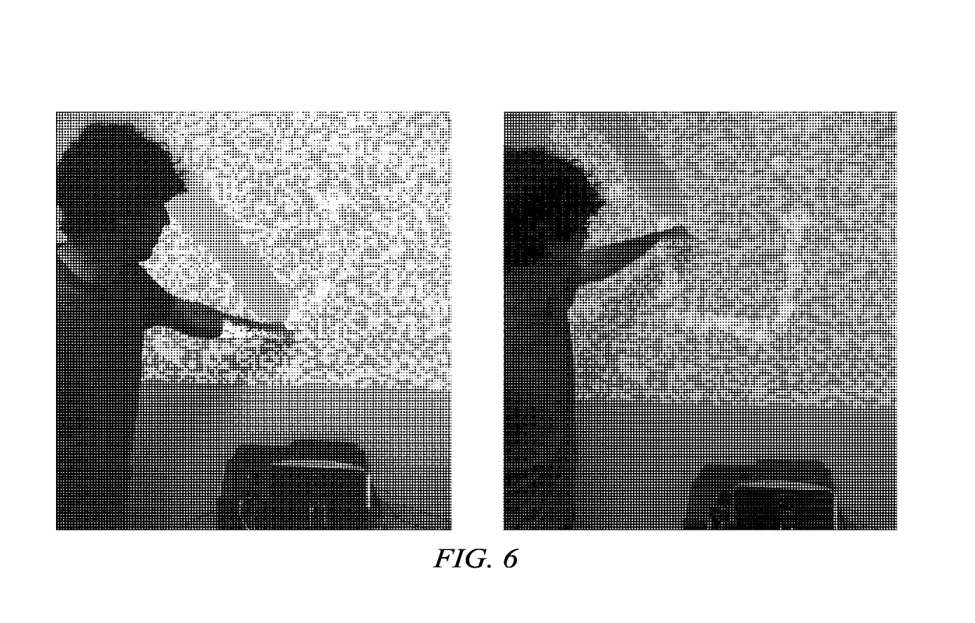

FIG. 6 is an embodiment of a hand painting demo enabled by the touch detection. In FIG. 6, a demonstration of hand-painting is shown, which implements the touch detection utilizing a camera projector. A disk may be drawn on a projected image at the coordinates where the touch was sensed. Thus, touch-based interactivity on arbitrary, non-engineered projection surfaces and frame-rate depth sensing are enable utilizing a camera projector, such as, a camera and a DLP projector. Such a scheme, is capable of utilizing one camera, which is a lower cost when compared to other means of getting depth information that require dual cameras or time-of-flight cameras.

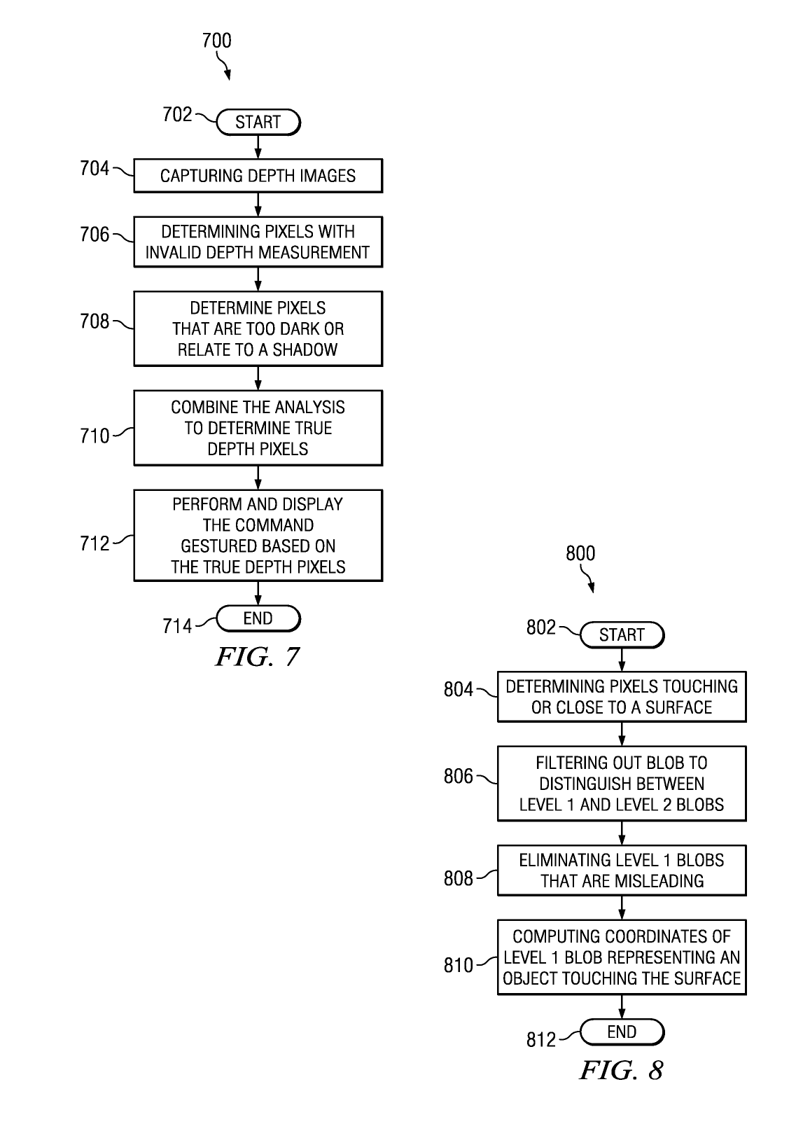

FIG. 7 is an embodiment of a flow diagram depicting a method 700 for displaying or performing a command based on gesture on a projection surface. The method 700 starts at step 702 and proceeds to step 704. At step 706, the method 700 determines the pixels with invalid depth measurements, which may be detected in a stereo algorithm via left-right consistency checks and local curvature analysis of the matching function. At step 708, the method 700 determines illegal depth pixels, which may be pixels with depth measurements that seem to belong behind the projection surface or shadow/dark pixels. Shadow/dark pixels are pixels illuminated by the ambient light in the scene and not by the projector. At step 710, the method 700 combines the above analyses to determine true depth pixels. At step 712, the method 700 performs and displays the command gestured based on the true depth pixels analyses. The method 700 ends at step 714.

Due to illumination conditions and visibility constraints, depth estimates may contain a significant amount of spurious measurements. Without a filtering operation, a touch detection system that relies on depth information may produce false alarms, i.e., report touch events even though there is no object near the surface. Utilizing a dual-threshold approach aims to mitigate these problems by defining two overlapping depth zones above the touch surface, and by imposing a number of constraints on allowable detections. For example, when a user touches the surface of interest with a finger or palm, the rest of user's hand or forearm will also be very close, but slightly further, from the surface. This observation relates to the physical characteristics of a human body.

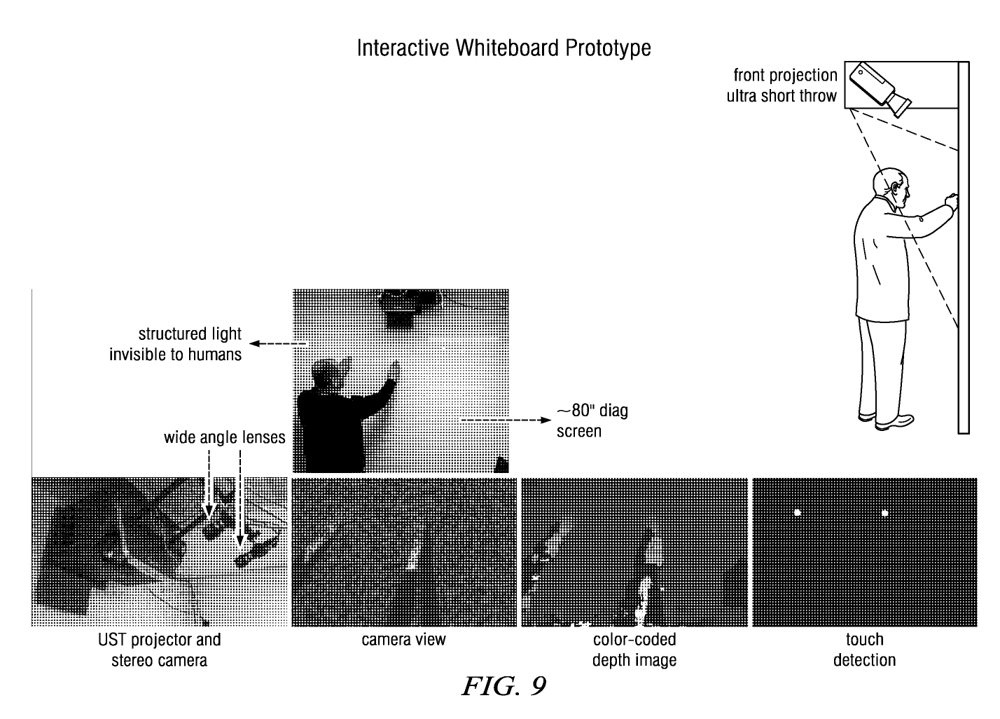

FIG. 8 is an embodiment of a method 800 for enabling an interactive surface. The method 800 starts at step 802 and proceeds to step 804. At step 804, the method determines the pixels in a depth image that relate to an object touching or in close proximity to a related surface, i.e. hovering just above the surface. Hence, the method 800 finds the pixels with a depth that is within the [d1, d2] depth interval, where d1 is marginally above the projection surface depth d0. The method 800 may apply morphological operations to clean up the spurious pixels and to fill in holes. The pixel found is referred to herein as ‘Blobs’.

At step 806, the method 800 filters out blobs with less than s1 pixel area size, which will be referred herein as level1 blob. The remaining blobs are referred to herein as level2 blobs. Hence, the method 800 determines that the level1 blob(s) is/are a touch point on the surface, which tends to be a smaller size cluster of pixels. Whereas, a level 2 blob tends to be a larger cluster of pixels.

If a level1 blob is indeed caused by the tip of a hand, finger, pointer and the likes, touching the surface, it is likely connected to an object, such as, the rest of the hand, forearm, pointer or the likes, which is extending slightly further from the surface. Accordingly, the method 800 determines the pixels which have depth within the [d3, d4] depth interval, wherein d1<d3<d2, and d2<d4 (i.e., a depth zone that overlaps with the first one but extends farther from the surface). The method 800 then may apply morphological operations to clean up the spurious pixels and to fill in holes. The method 800 then filters out blobs which have less than s2 pixel area size, wherein s1<s2. The remaining blobs are determined to be level2 blobs.

At step 808, the method 800 eliminates level1 blobs that are not connected to a level 2 blob and level1 blobs that are larger than their related level2 blob. Thus, the method 800 may apply a logical AND operation between level1 and level2 binary blob bitmasks to find out overlapping pixels.

At step 810, the method 800 computes a representative touch coordinate for the remaining level1 blob. Hence, the method 800 computes the centroid (x,y) of the pixels that have the lower 10-percentile of depth values found on that blob and declare a “touch event” at the (x,y) coordinate. The method 800 end at step 812.

In one embodiment, an intensity-based appearance model of the scene to infer foreground pixels is utilized. If there is indeed a user's hand or arm in the camera's field of view, we would expect the intensity model to detect a change in the scene as well. Accordingly, the method 800 may use the intensity images to build and maintain an appearance-based model of the scene. For instance, for each pixel, the method 800 may compute the running mean value of pixel intensity values over time. If the current pixel intensity deviates from the modeled value beyond a threshold, the method 800 may label the pixel as “foreground” and then apply morphological operations to clean up this foreground binary image to infer foreground blobs.

The method 800, then, may re-label the level1 blobs that overlap with the same foreground blob, which eliminates generating multiple level1 blobs from the same hand or finger. In yet another embodiment, the method 800 may analyze the depth range observed within each level1 blob. If the range is larger that a threshold, the level1 blob is suppressed or eliminated.

While the foregoing is directed to embodiments of the present invention, other and further embodiments of the invention may be devised without departing from the basic scope thereof, and the scope thereof is determined by the claims that follow.

What is claimed is:

1. A method of a digital processor for enabling an interactive surface, comprising:
determining pixels of a depth image relating to an object at least one of touching or in close proximity to a related surface;
differentiating between a small and a larger cluster of pixels;
determining smaller cluster of pixels to be a level1 blob and larger cluster of pixels to be a level2 blob and declaring the level1 blob an object touching the surface; and
computing the coordinates of the level1 blob and repeating the process to enable the interactive surface.

2. The method of claim 1, wherein computing the coordinates comprises computing centroid (x,y) of the pixels of the level1 blob.

3. The method of claim 1, wherein the step of determining smaller cluster of pixels to be a level1 blob comprises a step for determining pixels with a depth that is within the [d1, d2] depth interval, wherein d1 is marginally above the projection surface depth d0.

4. The method of claim 1 further comprising at least one of:
applying morphological operations to clean up the spurious pixels and to fill in holes; and
eliminating level1 blobs not connecting to a level 2 blob;
eliminating level1 blobs larger than their related level2 blob; and
utilizing intensity images for at least one of building and maintaining an appearance-based model of the scene, wherein deviating from the modeled value beyond a threshold the method determines the pixel to be a foreground pixel and re-labeling the level1 blobs overlapping with the same foreground blob and eliminates generating multiple level1 blobs from the same touch of an object;
eliminating a level1 blob when the depth range of the level1 blob is larger than a threshold; and utilizing hidden projection patterns for depth sensing, wherein the structured light is at least one of a structured light, stereo vision, and unstructured light.

5. The method of claim 1, wherein the step of differentiating between a small and a larger cluster of pixels comprises applying a logical AND operation between level1 and level2 binary blob bitmasks to find out overlapping pixels.

6. The method of claim 1, wherein the step of determining larger cluster of pixels to be a level2 blob comprises a step for determining the pixels having depth within a threshold depth interval.

7. An interactive surface, comprising:
means for determining pixels of a depth image relating to an object at least one of touching or in close proximity to a related surface;
means for differentiating between a small and a larger cluster of pixels;
means for determining smaller cluster of pixels to be a level1 blob and the larger cluster of pixels to be a level2 blob and means for declaring the level1 blob an object touching the surface; and
means for computing the coordinates of the level1 blob and repeating the process to enable the interactive surface.

8. The interactive surface 7, wherein the means for computing the coordinates comprises means for computing centroid (x,y) of the pixels of the level1 blob.

9. The interactive surface claim 7, wherein the means for determining smaller cluster of pixels to be a level1 blob comprises a means for determining pixels with a depth that is within the [d1, d2] depth interval, wherein d1 is marginally above the projection surface depth.

10. The interactive surface claim 7 further comprising at least one of:
means for applying morphological operations to clean up the spurious pixels and to fill in holes; and
means for eliminating level1 blobs not connecting to a level 2 blob;
means for eliminating level1 blobs larger than their related level2 blob; and
means for utilizing intensity images for at least one of building and means for maintaining an appearance-based model of the scene, wherein deviating from the modeled value beyond a threshold the method determines the pixel to be a foreground pixel and re-labeling the level1 blobs overlapping with the same foreground blob and eliminates generating multiple level1 blobs from the same touch of an object;
means for eliminating a level1 blob when the depth range of the level1 blob is larger than a threshold; and
means for utilizing hidden projection patterns for depth sensing, wherein the structured light is at least one of a structured light, stereo vision, and unstructured light.

11. The interactive surface claim 7, wherein the means for differentiating between a small and a larger cluster of pixels comprises means for applying a logical AND operation between level1 and level2 binary blob bitmasks to find out overlapping pixels.

12. The interactive surface claim 7, wherein the means for determining larger cluster of pixels to be a level2 blob comprises a means for determining the pixels having depth within a threshold depth interval.

13. A non-transitory computer readable medium comprising computer instructions, when executed perform a method for enabling an interactive surface, the method comprising:
determining pixels of a depth image relating to an object at least one of touching or in close proximity to a related surface;
differentiating between a small and a larger cluster of pixels;
determining smaller cluster of pixels to be a level1 blob and the larger cluster of pixels to be a level2 blob and declaring the level1 blob an object touching the surface; and
computing the coordinates of the level1 blob and repeating the process to enable the interactive surface.

14. The non-transitory computer readable medium of claim 13, wherein computing the coordinates comprises computing centroid (x,y) of the pixels of the level1 blob.

15. The non-transitory computer readable medium of claim 13, wherein the step for determining smaller cluster of pixels to be a level1 blob comprises a step for determining pixels with a depth that is within the [d1, d2] depth interval, wherein d1 is marginally above the projection surface depth d0.

16. The non-transitory computer readable medium of claim 13 further comprising at least one of:
applying morphological operations to clean up the spurious pixels and to fill in holes; and
eliminating level1 blobs not connecting to a level 2 blob;
eliminating level1 blobs larger than their related level2 blob; and
utilizing intensity images for at least one of building and maintaining an appearance-based model of the scene, wherein deviating from the modeled value beyond a threshold the method determines the pixel to be a foreground pixel and re-labeling the level1 blobs overlapping with the same foreground blob and eliminates generating multiple level1 blobs from the same touch of an object;
eliminating a level1 blob when the depth range of the level1 blob is larger than a threshold; and
utilizing hidden projection patterns for depth sensing, wherein the structured light is at least one of a structured light, stereo vision, and unstructured light.

17. The non-transitory computer readable medium of claim 13, wherein the step of differentiating between a small and a larger cluster of pixels comprises applying a logical AND operation between level1 and level2 binary blob bitmasks to find out overlapping pixels.

18. The non-transitory computer readable medium of claim 13, wherein the step of determining larger cluster of pixels to be a level2 blob comprises a step for determining the pixels having depth within a threshold depth interval.
